(19) United States
(12) Patent Application Publication
(10) Pub. No.: US 2001/0004110 A1
(43) Pub. Date: Jun. 21, 2001

(54) Hydraulic jack

(76) Inventor: Kyozi Sawano, Kani-shi (JP)

Correspondence Address: McGLEW AND TUTTLE, P.C., SCARBOROUGH STATION, SCARBOROUGH, NY, 10510-0827, US

(21) Appl. No.: 09/735,451

(22) Filed: Dec. 12, 2000

(30) Foreign Application Priority Data
Dec. 13, 1999 (JP) 352476/1999

(51) Int. Cl. B66F 3/00

(52) U.S. Cl. 254/124

(57) ABSTRACT

To facilitate an operation for feeding a jack part into a desired position. A jack part 2, which extends when pressure oil from an oil pressure supply and discharge part 1 is supplied and contracts when oil is recovered to the oil pressure supply and discharge part 1, is set to a pantograph type, and a wheel 5 is held in front which is one end in a folded state.

### BACKGROUND OF THE INVENTION

This invention relates to a hydraulic jack set to a manually-operated type.

Various proposals have been heretofore made in connection with the hydraulic jack set to a manually-operated type. In principle, as shown in FIG. 4, the jack comprises an oil pressure supply and discharge part 1 and a jack part 2. The oil pressure supply and discharge part 1 turns oil from a tank 13 into pressure oil by means of an oscillating operation of an operating lever 11 with respect to a pump 12 and supplies the oil to the jack part 2 through a pipe 3. On the other hand, oil from the jack part 2 is returned to the tank 13 by an opening operation of a depressurizing valve 14. It is set so that the jack part 2 extends when pressure oil from the oil pressure supply and discharge part 1 is supplied while contracts when pressure oil is discharged.

Accordingly, in the conventional hydraulic jack, for example, the jack part 2 is located at a desired position for extension and contraction thereof to enable movement of heavy articles up and down. Further, where the jack part 2 is set to a pantograph type, it is possible to set an elevating stroke higher than the case where the jack part 2 is set to a cylinder type.

However, in the jack part 2 set to a pantograph type, the elevating stroke is large, and therefore, it is necessary to stabilize the jack when the latter is installed on the installing surface such as the surface of the earth. For example, though not shown, a base plate or the like constituting the lower end of the jack part 2 is formed as large as possible.

On the other hand, where the hydraulic jack of this kind is located at a deep position, in most case, the operating lever 11 constituting the oil pressure supply and discharge part 1 is used as a pressing member by which the jack part 2 is slidably moved and fed into the desired position.

In this case, the larger the base plate or the like constituting the lower end of the jack part 2, in order to enhance the stability when installed, as described above, there poses an inconvenience that the feeding operation is difficult.

### SUMMARY OF THE INVENTION

This invention has been accomplished in view of the aforementioned circumstances. An object of the invention is to provide a hydraulic jack in which an operation for feeding a jack part into a desired position is facilitated to be optimum for expecting the enhancement of the wide-use property thereof.

For achieving the aforesaid object, a means of the present invention comprises an oil pressure supply and discharge part, and a jack part connected to the oil pressure supply and discharge part through a flow passage, said jack part being provided with a hydraulic cylinder, a pantograph type link connected to the hydraulic cylinder through a driving link, and a wheel provided at a suitable position of the pantograph type link.

In this case, preferably, the pantograph type link comprises a pair of rotatable lower links, a pair of upper links pivotally mounted on the extreme ends of the lower links, respectively, through shafts, and pressure receiving plates provided on the upper ends of the upper links, respectively, the driving link is connected rotatably between the hydraulic cylinder and the lower links, and the wheel is mounted on one of the shafts.

In this case, preferably, the lower links and the upper links are provided in a paired relation before and behind, and the wheel is mounted on the front shaft for pivotally mounting the front lower link and the front upper link.

Further, in the above-described means, preferably, a guide tube comprising an outer tube and an inner tube slidably inserted into the outer tube is connected to the jack part, the oil pressure supply and discharge part is provided with a holder member, the pipe is inserted into the guide tube, and the guide tube is connected to the holder member separably and rotatably.

In this case, preferably, an operating rod extending in a direction opposite to the guide tube is connected to the holder member.

Further, preferably, the jack part has a base plate placed on the installing surface movably, and the base plate is connected to the inner tube through a connecting construction.

Furthermore, preferably, the oil pressure supply and discharge part has a pump and a tank, said tank comprising a bellows type bladder for setting a volume chamber therein, and a protective casing formed of a visible material for receiving the bladder therein.

### BRIEF DESCRIPTION OF THE DRAWINGS

FIG. 1 is a front view showing a state that a jack part of a hydraulic jack according to one embodiment of this invention is folded;

FIG. 2 is a front view in a reduced scale showing an oil pressure supply and discharge part connected to the jack part in FIG. 1 along with a pipe and a guide tube;

FIG. 3 is an enlarged front view showing a state that the jack part in FIG. 1 is extended; and

FIG. 4 is a circuitry view showing a conventional hydraulic jack in terms of principle.

### DETAILED DESCRIPTION OF THE PREFERRED EMBODIMENTS

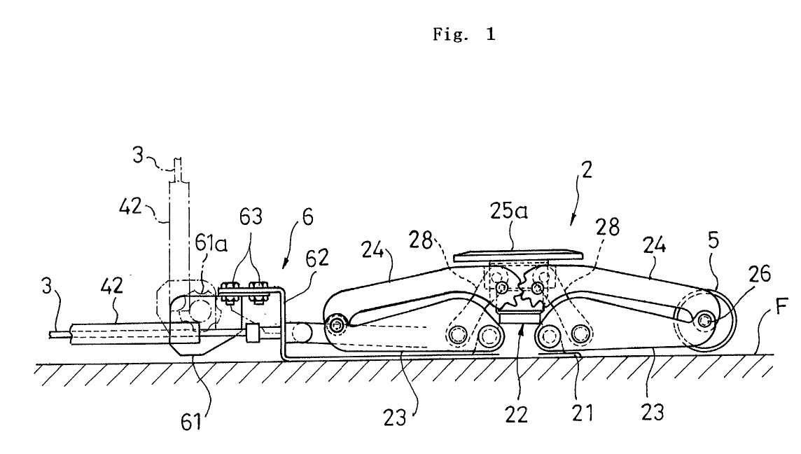

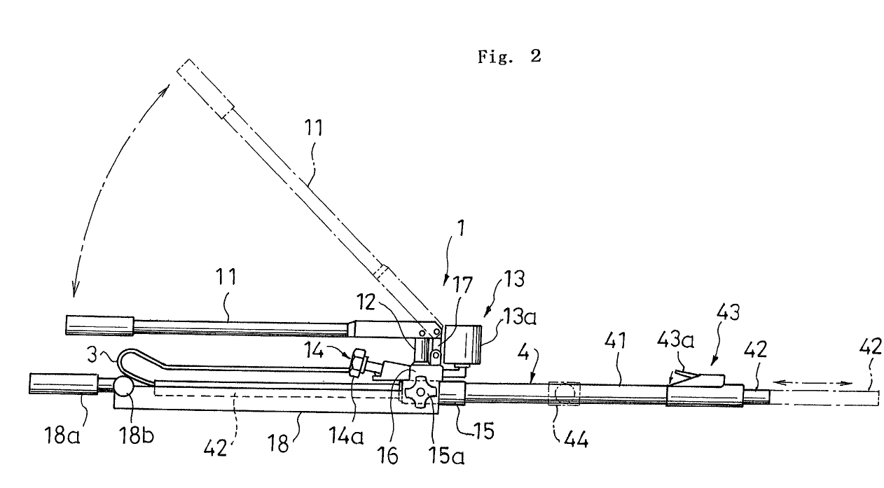

This invention will now be described on the basis of the embodiments shown in the drawings. A jack part 2 in a hydraulic jack according to this invention shown in FIG. 1 is communicated with an oil pressure supply and discharge part 1 constituted as shown in FIG. 2, for example, through a pipe 3 which is a flow passage.

First, the oil pressure supply and discharge part 1 will be described. This oil pressure supply and discharge part 1 comprises an operating lever 11, a pump 12, a tank 13, and a depressurizing valve 14. Oil from the tank 13 is supplied as pressure oil to the jack part 2 (see FIG. 1) through the pipe 3 by operation of the pump 12 caused by an oscillating operation of the operating lever 11, whereas return oil which is oil from the jack part 2 is likewise flown into the tank 13 through the pipe 3 by an opening operation of the depressurizing valve 14 caused by manual operation.

At this time, in the oil pressure supply and discharge part 1, the pump 12, the tank 13, and the depressurizing valve 14 are gathered at a mount part 16 provided integrally on the upper end of a holder member 15 inserted rotatably into a guide tube 4.

The operating lever 11 is pivotally mounted on the mount part 16 through a link 17 and is connected to the pump 12, which lever 11 is oscillated up and down, as shown by an imaginary arrow and an imaginary diagram in FIG. 2, to operate the pump 12.

It is noted of course that the operating lever 11 is not formed to be integral, as shown, but may be formed capable of being extended and contracted, though not shown.

The pump 12 is set so that when in operation, oil from the tank 13 may be supplied as pressure oil to the jack part 2 through the pipe 3, the pump 12 having a well-known construction being used.

In principle, the tank 13 has a volume chamber (not shown) making volume variable while being separated from gas, and is set so that a fixed quantity of oil may be received in the volume chamber.

Where the tank 13 comprises a bladder (not shown) which presents a bellows appearance and of which interior is set to the volume chamber, the bladder being received into a protective casing 13a formed of a visible material, since the volume chamber for receiving oil therein is separated from gas, even if the tank 13 should be fallen sideways or turned upside down, there could be avoided an inconvenience that the gas within the volume chamber flows into the pump 12 to make it impossible to realize a fixed pump operation or flows into the jack part 2 to make it impossible to provide a fixed jack pressure.

Further, since the bladder of which interior is formed into the volume chamber separated from gas is received within the protective casing 13a formed of a visible material, even if, for example, the jack part 2 is so deeply positioned that the extension and contraction state cannot be visualized, it is possible to grasp the extension and contraction state of the jack part 2 by visualizing a so-called swelling of the bladder.

The depressurizing valve 14 is set to a check valve construction for checking a flow of oil from the jack part 2, in which the check valve state is released by a rotational operation with respect to an operating part 14a formed from a dial or the like to return oil from the jack part 2 to the tank 13.

The holder member 15 is inserted separably into a guide tube 4 described later and is held integrally on the extreme end of an operating rod 18 extended at the rear of the guide tube 4 and in the axial direction.

That is, in the form of embodiment shown, it is set so that when the jack part 2 is located at a desired position through the guide tube 4, the operating lever 11 constituting the oil pressure supply and discharge part 1 is not pressed but the operating rod 18 is pressed.

By the setting as described above, when the jack part 2 is located at a desired position, a so-called exclusive-use pressing member is to be provided, and the operating lever 11 need not to be used as a pressing member. Accordingly, as compared with the case where the operating lever 11 is used as a pressing member, the operability is enhanced, and locating of the jack part 2 can be executed positively.

Besides, since the operating lever 11 is not used as the pressing member, as compared with the case where the operating lever 11 is as the pressing member, the operating lever 11 can be set to a so-called insignificant constitution as long as the fixed pump operation is enabled.

Therefore, in the operating rod 18 to be an exclusive-use pressing member, it is preferred that handles 18a and 18b are provided at the rear end thereof, as shown in FIG. 1.

As shown, the operating rod 18 is formed to have a section in the shape of a shallow U, and has an axial fixed strength. The rear end of the guide tube 4 described later is present at the inside of the lever so as to protect the rear end of the guide tube 4.

In the oil pressure supply and discharge part 1 formed as described above, the supply and discharge of pressure oil with respect to the lack part 2 can be executed by the operation of a pump caused by the operating lever 11 and the opening of the depressurizing valve 14, and in addition, the jack part 2 can be located to a fixed position positively by the operating rod 18.

Besides, the pump 12, the tank 13, and the holder member 15 for holding the depressurizing valve 14, which constitute the main part of the oil pressure supply and discharge part 1, are connected separably to the guide tube 4 whereby the oil pressure supply and discharge part 1 may be rotated relative to the guide tube 4. Accordingly, it is possible to maintain the guide tube 4, that is, the jack part 2 in a suitable rotating state without being limited to the rotating state of the oil pressure supply and discharge part 1.

Further, the holder member 15 is separated from the guide tube 4, and the pipe 3 described later is folded, whereby the full length of the hydraulic jack can be shortened. Accordingly, the hydraulic jack can be compacted.

The oil pressure supply and discharge part 1 is integrated in the form of a rod with the jack part 2 through the guide tube 4. Therefore, where the oscillating operation of the operating lever 11 cannot be executed, the pipe 3 portion is folded to release the rod-like state so as to enable the oscillating operation of the operating lever 11.

While in the illustration, means for securing the holder member 15 to the guide tube 4 comprises a fastening bolt 15a engaged with the holder member 15, it is to be noted that instead of the former, for example, a fastening means comprising a chuck construction or the like may be employed, though not shown.

The pipe 3 for communicating the oil pressure supply and discharge part 1 with the jack part 2, that is, for forming an oil passage therebetween, is generally utilized for hydraulic apparatus of this kind, and has a fixed pressure-resistant ability and is set to be rich in flexibility.

It is to be noted of course that the length of the pipe 3 is set to a length, when the guide tube 4 described later is extended at the maximum, not to impede such extension.

The guide tube 4 for causing the pipe 3 to be inserted therein to separably connect the guide holder 15 can be extended and contracted with an inner tube 42 slidably inserted into an outer tube 41. The oil pressure supply and discharge part 1 is connected separably to the rear end which is the left end in FIG. 2 of the outer tube 41, and the jack part 2 described later is connected to the extreme end which is the right end in FIG. 1 of the inner tube 42 (see FIG. 1).

Incidentally, the connection of the jack part 2 to the extreme end of the inner tube 42 is achieved by a connecting construction 6 described later. In this case, it is set so that as shown in the imaginary line of FIG. 1, the inner tube 42, that is, the guide tube 4 may be oscillated relative to the jack part 2.

Since it is set so that the guide tube 4 may be oscillated relative to the jack part 2, as described above, it is advantageous in that the jack part 2 can be located in a desired suitable extension and contraction direction irrespective of the extending direction of the guide tube 4.

On the other hand, the extension and contraction state of the guide tube 4 is maintained by a stopper 43 provided in the outer periphery at the extreme end of the outer tube 41. The stopper 43 has a pin which is connected to the extreme end of a lever 43a pivotally mounted on a holder part held fixedly on the outer periphery at the extreme end of the outer tube 41, though not shown in detail.

The lever 43a urges so that the pin at the extreme end is pressed down by the urging force of an urging member not shown. It is set, though not shown, that the pin may, when moves down, pass though a hole bored integrally in the holder part and the outer tube 41, and a hole bored in the inner tube 42 aimed at the aforesaid hole.

It is noted of course that with respect to the holes in the inner tube 42, a plurality of holes is bored at suitable intervals in an axial direction of the inner tube 42.

Therefore, the stopper 43 releases, at least when the rear end of the lever 43a is pressed down to pull the pin out of the holes in the inner tube 42, the connected state between the outer tube 41 and the inner tube 42, to enable the relative movement therebetween, that is, the pulling in/out of the inner tube 42 relative to the outer tube 41.

Incidentally, the guide tube 4 has a handle 44 like the handle 18b at the rear end of the operating rod 18 to enable rotation thereof about the axis of the guide tube 4 at the time of rising and falling operation along with the handle 18b. However, it is of course that the provision of the handle 44 may be omitted.

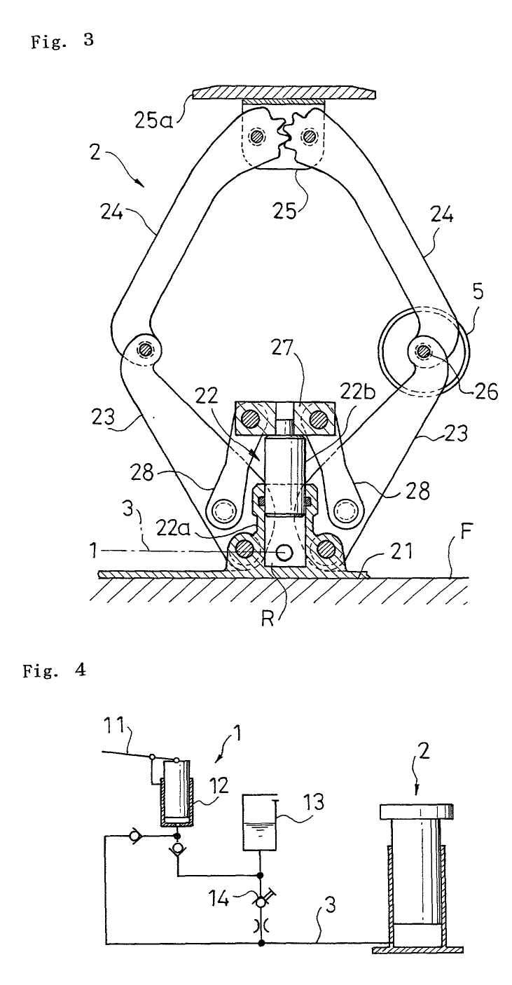

It is set so that the jack part 2 may be extended or contracted by the supply or discharge of oil in the oil pressure supply and discharge part 1. That is set to a pantograph type even in this invention, as shown in FIG. 3 also.

In this invention, however, the jack part 2 holds a wheel 5 at the extreme end which is one end (right end in FIG. 1) in the folded state shown in FIG. 1.

Describing further, this jack part 2 has a base plate 21 placed on the installing surface F, and a hydraulic cylinder 22 which extends up and down is provided on the upper surface of the base plate 21, and has an extension link linked.

In this invention, the base plate 21 is formed as large as possible, and is set, in the illustration, to be large in an axial direction of the hydraulic jack which is a lateral direction in FIGS. 1 and 3, in terms of the connecting construction 6 described later.

In the hydraulic cylinder 22, a ram 22b can be moved in and out of a cylinder part 22a formed integral with the upper surface of the base plate 21, and a pressure chamber R defined between the lower end of the ram 22b and the inner bottom of the cylinder part 22a is communicated with the oil pressure supply and discharge part 1 through the pipe 3.

Therefore, the hydraulic cylinder 22 extends when pressure oil from the oil pressure supply and discharge part 1 is supplied to the pressure chamber R, and contracts when oil in the pressure chamber R is returned to the oil pressure supply and discharge part 1.

The extension link has a pair of front and rear lower link members 23 whose lower ends are pivotally mounted to the base plate 21, a pair of front and rear upper link members 24 whose lower ends are pivotally mounted to the extreme ends of the lower link members 23, and a bracket 25 pivotally mounted to the upper end of the upper link member 24, and to the upper end of the bracket 25 is connected a pressure receiving plate 25a in which the upper end surface thereof is set to the main pressure receiving surface in the jack part 2.

Incidentally, the bracket 25 is set so as to be across and put on the hydraulic cylinder 22 when the jack part 2 is folded, that is, when the extension link is folded.

The extension link is pivotally mounted to the upper end of the lower link member 23 in front which is right-hand in FIGS. 1 and 3, and a wheel 5 is provided on a shaft 26 for pivotally mounting the lower end of the upper link member 24 likewise in front.

In this case, the wheel 5 may contact the installing surface F such as the surface of the earth in the state of being held at the extreme end which is one end (right end in FIGS. 1 and 3) in the state that the extension link is folded, and may be adjacent to the installing surface F at a position slightly elevated from the installing surface F.

When the wheel 5 is at a position slightly elevated, the other end of the jack part 2 in the folded state, that is, the rear end which is left end in FIGS. 1 and 3 is raised to thereby enable the contact of the wheel 5 with the installing surface F.

Further, where the wheel 5 is initially in contact with the installing surface F, the rear end of the jack part 2 in the folded state is moved up a little to enable the release of the state that the base plate 21 in the jack part 2 is totally in contact with the installing surface F.

Furthermore, since the wheel 5 is mounted on the shaft 26 for pivotally mounting the extreme end of the lower link member 23 and the lower end of the upper link member 24, it is not necessary to separately provide a shaft for pivotally mounting the wheel 5.

On the other hand, in the hydraulic cylinder 22, the bracket 27 is connected to the upper end of the ram 22b, and the upper ends of a pair of driving link members 28 are pivotally mounted to the bracket 27.

The lower ends of the pair of driving link members 28 are pivotally mounted to the neighborhoods of the lower ends of the pair of lower link members 23 constituting the extension link.

Therefore, in the jack part 2, the extension link is risen and fallen by the extension and contraction of the hydraulic cylinder 22 through the driving link members 28, and the pressure receiving plate 25a on the upper end of the extension link moves up and down.

In the jack part 2, the rear end thereof is raised when folded whereby the lower end in the outer periphery of the wheel 5 may be placed in contact with the installing surface F. At that time, the jack part 2 can be moved to a suitable position by rolling of the wheel 5.

Incidentally, in the illustration, the jack part 2 is connected to the guide tube 4, that is, the extreme end of the inner tube 42 by the connecting construction 6, as described previously.

The connecting construction 6 has a bracket 61 connected to the extreme end of the inner tube 42, a bracket 62 integral with the base plate 21 of the jack part 2, and a bolt and nut 63 for connecting both the brackets 61 and 62.

In the illustration, the bracket 61 has a fastening bolt 61a, and the oscillation of the bracket 61 relative to the bracket 62 can be executed by the rotating operation of the fastening bolt 61a.

The bracket 62 is made integral with the base plate 21 of the jack part 2 to lengthen the overall length thereof. Accordingly, the jack part 2 is hard to be fallen in the longitudinal direction which is the axial direction to increase the so-called stability.

At that time, the base plate 21 is to be extended backward of the jack part 2, which comprises no obstruction encountered when the jack part 2 is fallen ahead to place the wheel 5 in contact with the installing surface F.

It is to be noted of course that in connecting the extreme end of the inner tube 42 to the bracket 61, so-called securing may be employed instead of the means shown in the figure. In this case, alternatively, a material rich in elasticity, for example, such as rubber, may be interposed between the bracket 61 and the extreme end of the inner tube 42 to provide a so-called play therebetween.

The hydraulic jack formed as described above can be utilized such that the jack part 2 is located to a desired position, and the jack part 2 is extended and contracted by operation of the oil pressure supply and discharge part 1.

Where a position for locating the jack part 2 is, for example, a deep position, the inner tube 42 is pulled out of the outer tube 41 to lengthen the guide tube 4, whereas the operating rod 18 is pushed to locate the jack part 2 to a desired deep position.

Where in locating the jack part 2 to a desired position, the jack part 2 need be fallen sideways, the guide tube 4 is rotated, that is, rotated about the axis thereof by operation relative to the handle 18b in the operating rod 18 or the handle 44 in the guide tube 4.

Further, where the oil pressure supply and discharge part 1 need be deviated in the rotating direction with respect to the jack part 2 including the case where the jack part 2 is fallen sideways, that is, where the extension and contraction direction of the jack part 2 need be deviated with respect to the oscillating direction of the operating lever 11 in the oil pressure supply and discharge part 1, the holder member 15 is rotated in the outer periphery of the guide tube 4.

Where the holder member 15 is separated from the guide tube 4 and the pipe 3 is bent, and the oil pressure supply and discharge part 1 is integral with the jack part 2 in a rod-like fashion through the guide tube 4 to fail to execute the oscillating operation of the operating lever 11, the oil pressure supply and discharge part 1 can be operated such as that the operating lever 11 is subjected to the oscillating operation irrespective of the so-called direction of the jack part 2.

After the use, the jack part 2 is contracted, by the operation of the depressurizing valve 14 in the oil pressure supply and discharge part 1, to draw the jack part 2 from the downward of the heavy article or the like, thus retreating and removing the whole for re-use.

At that time, the holder member 15 is separated from the guide tube 4, and he pipe 3 is bent, whereby the overall length is shortened, and thus the hydraulic jack can be compacted.

While in the foregoing, the pipe 3 for communicating the oil pressure supply and discharge part 1 with the jack part 2 is inserted into the guide tube 4 formed to be extended and contracted, it is noted of course that instead, though not shown, the guide tube 4 may be omitted, and accordingly, connection may be made merely by the pipe 3 rich in flexibility, and no integrity between them, that is, freedom in direction therebetween may be provided.

Further, the oil pressure supply and discharge part 1 and the jack part 2 may be joined directly, and connected through the flow passage.

As described above, according to the invention, since the guide tube inserted into a part of the pipe for communicating the oil pressure supply and discharge part with the jack part is set to be extended and contracted by slidably inserting the inner tube into the outer tube, the jack part can be easily located, for example, to a deep position from the position of the oil pressure supply and discharge part.

Further, according to the invention, since the oil pressure supply and discharge part is separably connected to the guide tube, the oil pressure supply and discharge part can be rotated relative to the guide tube. Accordingly, the guide tube, that is, the jack part can be maintained in a suitable rotating state without being restricted by the rotating state of the oil pressure supply and discharge part.

Where the oil pressure supply and discharge part is separated from the guide tube, and the pipe for communicating the oil pressure supply and discharge part with the jack part is bent, the overall length of the hydraulic jack can be shortened, and accordingly, the hydraulic jack can be compacted.

At this time, there can be released the state that the oil pressure supply and discharge pat is integral with the jack part in a so-called rod-like fashion through the guide tube. Accordingly, the operation of the oil pressure supply and discharge part can be executed such as that the operating lever is oscillated in the oil pressure supply and discharge part irrespective of so-called direction of the jack part.

Where in the invention, the tank constituting the oil pressure supply and discharge part has the volume chamber for making the volume variable while being separated from gas, even if the state should occur in which the tank is fallen sideways or turned upside down, there can be avoided in advance an inconvenience that the gas within the volume chamber flows into the pump failing to realize the fixed pump operation, or flows into the jack part failing to provide a fixed jack pressure.

Further, where the bladder constituting the volume chamber is received in the protective casing formed of a visible material, for example, even where the jack part is located at a so deep position that cannot visualize the extension and contraction state, the so-called swelling state of the bladder is visualized to enable grasping the extension and contraction state of the jack part.

Further, according to the invention, since the wheel of which outer peripheral lower end is made adjacent to the installing surface such as the surface of the earth is held at the extreme end which is one end in the state that the jack part is folded, the rear end which the other end of the jack part can be raised to bring the outer peripheral lower end of the wheel into contact with the installing surface, thus facilitating the feeding operation of the jack part into the desired position.

Further, since the wheel is provided on the shaft for pivotally mounting the upper end of the lower link member to the lower end of the upper link member, the shaft for pivotally mounting the wheel need not be provided separately. Accordingly, the jack part formed into a pantograph type heretofore proposed can be utilized without requiring a considerable change in design.

As a result, according to this invention, the feeding operation with respect to the desired position of the jack part is facilitated, without requiring for an operator to pass through under a heavy article such as a vehicle, that is, while securing safety of operation, for example, the jack part can be located to a deep position, providing an advantage being optimum for expecting the enhancement of the wide-use property.

What is claimed is:

1. A hydraulic jack comprising: an oil pressure supply and discharge part, and a jack part connected to the oil pressure supply and discharge part through a flow passage, said jack part being provided with a hydraulic cylinder, a pantograph type link connected to the hydraulic cylinder through a driving link, and a wheel provided at a suitable position of the pantograph type link.

2. The hydraulic jack according to claim 1, wherein the pantograph type link comprises a pair of rotatable lower links, a pair of upper links pivotally mounted on the extreme ends of the lower links, respectively, through shafts, and pressure receiving plates provided on the upper ends of the upper links, respectively, the driving link is connected rotatably between the hydraulic cylinder and the lower links, and the wheel is mounted on one of the shafts.

3. The hydraulic jack according to claim 2, wherein the lower links and the upper links are provided in a paired relation before and behind, and the wheel is mounted on the front shaft for pivotally mounting the front lower link and the front upper link.

4. The hydraulic jack according to claim 1, wherein a guide tube comprising an outer tube and an inner tube slidably inserted into the outer tube is connected to the jack part, the oil pressure supply and discharge part is provided with a holder member, the pipe is inserted into the guide tube, and the guide tube is connected to the holder member separably and rotatably.

5. The hydraulic jack according to claim 4, wherein an operating rod extending in a direction opposite to the guide tube is connected to the holder member.

6. The hydraulic jack according to claim 4, wherein the jack part has a base plate placed on the installing surface movably, and the base plate is connected to the inner tube through a connecting construction.

7. The hydraulic jack according to claim 1, wherein the oil pressure supply and discharge part has a pump and a tank, said tank comprising a bellows type bladder for setting a volume chamber therein, and a protective casing formed of a visible material for receiving the bladder therein.
